(19) United States
(12) Patent Application Publication
(10) Pub. No.: US 2009/0010538 A1
(43) Pub. Date: Jan. 8, 2009

(54) Apparatus and method for automatically computing gamma correction curve

(75) Inventor: Min-Seok Kim, Seoul (KR)

Correspondence Address: JONES DAY, 222 EAST 41ST ST, NEW YORK, NY, 10017, US

(73) Assignee: Core Logic, Inc.

(21) Appl. No.: 12/215,203

(22) Filed: Jun. 25, 2008

(30) Foreign Application Priority Data
Jun. 26, 2007 (KR) 10-2007-0063014

(51) Int. Cl. G06K 9/03

(52) U.S. Cl. 382/167

(57) ABSTRACT

The present invention relates to apparatus and method for automatically computing a gamma correction curve. The apparatus according to the present invention comprises an image obtaining unit for receiving an input image data of a color chart through an image interface; a coordinate calculating unit for measuring input brightness values of a plurality of ROIs (Regions of Interest) of the input image and comparing an input brightness value of each ROI with a preset target brightness value of each ROI to calculate gamma correction coordinates for a plurality of points of a gamma correction curve; and a curve computing unit for applying interpolation to a plurality of the calculated gamma correction coordinates to compute a gamma correction curve.

### CLAIM OF PRIORITY

This application claims priority under 35 USC §119(a) to Korean Patent Application No. 10-2007-0063014, filed on Jun. 26, 2007, in the Korean Intellectual Property Office, the entire contents of which are hereby incorporated by reference.

### TECHNICAL FIELD

The present invention relates to an apparatus for automatically computing a gamma correction curve used in correcting brightness of a digital image, and in particular, to an apparatus for automatically computing and applying in real time a profile of a gamma correction curve used to correct brightness of an image by an image signal processor, and a method thereof.

### BACKGROUND

A digital photographing apparatus such as a digital camera or a camcorder includes an image signal processor which receives an input image data from an image sensor such as CCD (Charge Coupled Device) or CMOS (Complementary Metal-Oxide Semiconductor) and performs various image processing to generate a digital image data with improved image quality. The image signal processor improves image quality through various image processing, for example DPA (Dead Pixel Alive), LSC (Lens Shading Compensation), ACI (Adaptive Color Interpolation), color correction, gamma correction, hue/gain control, image effect, auto control or auto white balance.

The gamma correction among the above-mentioned image processing transforms a brightness distribution of an image nonlinearly so that an image signal input from an image sensor has WDR (Wide Dynamic Range). Because human vision responds to brightness of an image nonlinearly, when brightness of an image is linearly expressed in a limited bit depth, posterization occurs. Accordingly, gamma correction is required. The gamma correction encodes brightness of an image nonlinearly by mapping each color channel (R, G and B) of the image using a nonlinear curve (hereinafter referred to as a gamma correction curve) such as Rec. 709 transfer function.

To perform gamma correction, the image signal processor includes a register for storing coordinates of a gamma correction curve in the form of a lookup table. Generally, the number of coordinates included in the lookup table is 16 or 32. In each coordinate, X coordinate is color data before gamma correction, and Y coordinate is color data after gamma correction. The image signal processor performs gamma correction by mapping color data for each color channel, for example X to Y using the lookup table. The image signal processor maps color data that is not stored in the lookup table, by interpolation using adjacent coordinates.

Meanwhile, even through the same object is taken by an image sensor under the same intensity of illumination, a brightness distribution of an image varies according to the kind or performance of the image sensor. Thus, a gamma correction curve should be tuned in conformity with property of the image sensor. For example, in the case that an output value of an image data with low brightness outputted from the image sensor is large, a left portion of a gamma correction curve is moved downward. On the contrary, in the case that an output value of an image data with large brightness outputted from the image sensor is small, a right portion of a gamma correction curve is moved upward.

Conventionally, the gamma correction curve was mainly tuned by a manual method. The manual method changed each coordinate value stored in a lookup table of a register until a desired brightness distribution of an image is obtained, and tuned the gamma correction curve while watching the change of brightness distribution of the image with the naked eye.

However, the manual method has disadvantages that a considerable time is required to tune a gamma correction curve and a profile of the gamma correction curve varies according to tuners. And, the manual method has a difficulty in computing a gamma correction curve that is exactly suitable for a desired brightness distribution of an image.

### SUMMARY

The present invention was devised to solve the above-mentioned problems. An object of the present invention is to provide apparatus and method that can automatically compute a gamma correction curve used in correcting brightness of an image.

Another object of the present invention is to provide apparatus and method that can reflect a coordinate value of the computed gamma correction curve on a register of an image signal processor in real time.

Still another object of the present invention is to provide apparatus and method that can check the change of a brightness distribution of an image according to the automatically computed gamma correction curve in real time.

These and other features, aspects, and advantages of the present invention will be more fully described in the preferred embodiments of the present invention. And, the objects and advantages of the present invention can be implemented by configurations recited in the claims singularly or in combination.

To achieve the above-mentioned objects, an apparatus for automatically computing a gamma correction curve according to the present invention comprises an image obtaining unit for receiving an input image data of a color chart through an image interface; a coordinate calculating unit for measuring input brightness values of a plurality of ROIs (Regions of Interest) in the input image and comparing an input brightness value of each ROI with a preset target brightness value of each ROI to calculate gamma correction coordinates for a plurality of points of a gamma correction curve; and a curve computing unit for applying interpolation to a plurality of the calculated gamma correction coordinates to compute a gamma correction curve.

To achieve the above-mentioned objects, a method for automatically computing a gamma correction curve according to the present invention comprises receiving an input image data of a color chart through an image interface; measuring input brightness values of a plurality of ROIs in the input image and comparing an input brightness value of each ROI with a preset target brightness value of each ROI to calculate gamma correction coordinates for a plurality of points of a gamma correction curve; and applying interpolation to a plurality of the calculated gamma correction coordinates to compute a gamma correction curve.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a schematic block diagram illustrating a configuration of an apparatus for automatically computing a gamma correction curve according to the present invention.

FIG. 2 is a detailed block diagram illustrating a configuration of an apparatus for automatically computing a gamma correction curve according to a preferred embodiment of the present invention.

FIG. 3 is a graph illustrating a concept that an input brightness value of a predetermined bit number is mapped to an output brightness value of a predetermined bit number using a gamma correction curve to nonlinearly encode a brightness distribution of an image.

FIG. 4 is an exemplary display view illustrating a color chart image used to automatically compute a gamma correction curve.

FIG. 5 is an exemplary display view illustrating an ROI setting interface provided through a display.

FIG. 6 is an exemplary display view illustrating a gamma correction curve displayed through a graphic user interface.

FIG. 7 is an exemplary display view illustrating a gamma correction curve for each R, G and B channel.

FIG. 8 is an exemplary display view illustrating a brightness distribution for each R, G and B channel of ROI and a target brightness distribution of ROI.

FIG. 9 is a flow chart illustrating a method for automatically computing a gamma correction curve according to the present invention.

FIG. 10 is an internal block diagram of a general-purpose computer system used to perform the method for automatically computing a gamma correction curve according to the present invention.

### DETAILED DESCRIPTION

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

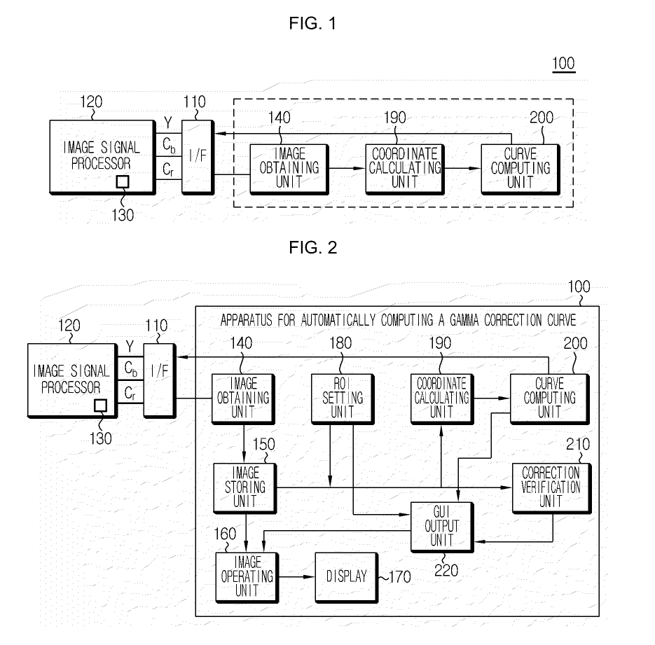

FIG. 1 is a schematic block diagram illustrating a configuration of an apparatus for automatically computing a gamma correction curve according to the present invention.

As shown in FIG. 1, an apparatus 100 for automatically computing a gamma correction curve according to the present invention is connected to an image signal processor 120 through an image interface 110. The image interface 110 is an I/O interface for interfacing data transmission between the image signal processor 120 and the apparatus 100 for automatically computing a gamma correction curve according to the present invention. The image signal processor 120 receives an input analogue image of an object from an image sensor, converts the analogue image into a digital image, performs various image processing and outputs the digital image data with improved image quality. The outputted digital image data may include a luminance data (Y) and chrominance data (C_{b} and Cᵣ) as shown in FIG. 1 or may include RGB data. However, the present invention is not limited to a specific format of digital image data.

The image signal processor 120 includes a gamma correction block 130 for correcting at least brightness distribution of an image. The gamma correction block 130 corrects a brightness distribution of an image by nonlinearly encoding the brightness distribution of the image according to a profile of a gamma correction curve stored in a register of the image signal processor 120. The profile of the gamma correction curve includes a plurality of gamma correction coordinates stored in a lookup table of the register. The gamma correction coordinate is a two-dimensional coordinate located on the gamma correction curve, in which an X coordinate value is an input brightness value and a Y coordinate value is an output brightness value mapped with the input brightness value. Preferably, the gamma correction block 130 corrects a brightness distribution of an image for each color channel (R, G and B).

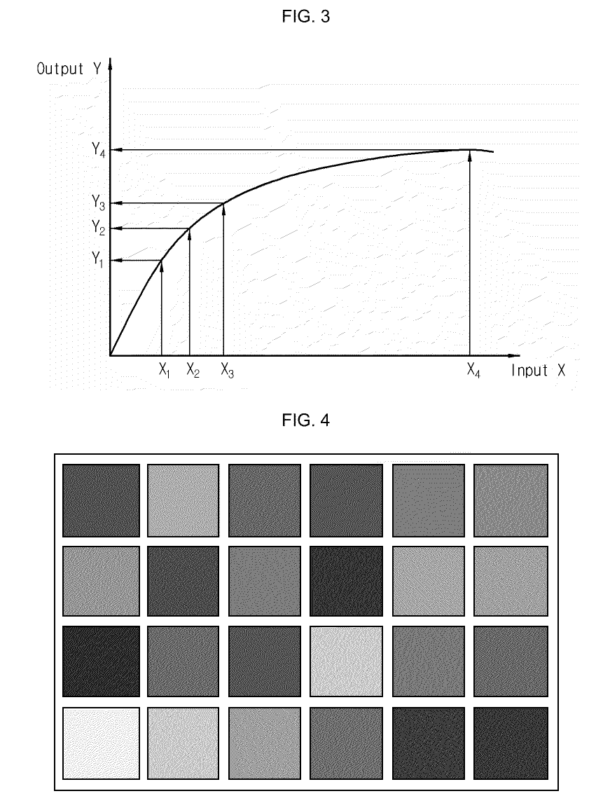

FIG. 3 is a graph illustrating a concept that the gamma correction block 130 encodes nonlinearly a brightness distribution of an image by mapping an input brightness value of a predetermined bit number to an output brightness value of a predetermined bit number using a gamma correction curve. Referring to FIG. 3, the gamma correction block 130 encodes input brightness values corresponding to X₁, X₂, X₃ and X₄ to output brightness values corresponding to Y₁, Y₂, Y₃ and Y₄, respectively. The input brightness value and the output brightness value may be 12 bit and 8 bit, 10 bit and 8 bit, or 8 bit and 8 bit. However, the present invention is not limited to specific bit numbers of input brightness value and output brightness value.

Meanwhile, gamma correction means nonlinear encoding of a brightness distribution of an image in consideration that human vision responds to brightness of an image nonlinearly. However, gamma correction may mean nonlinear encoding of a brightness distribution of an image to correct nonlinearity of a display device. In this case, the image signal processor 120 may be replaced with a typical graphic driver device connected to a display device, and the gamma correction block 130 is included in the graphic driver device and corrects a brightness distribution of an image to correct nonlinearity of the display device.

The image signal processor 120 can perform not only gamma correction, but also any one image processing selected from DPA (Dead Pixel Alive), LSC (Lens Shading Compensation), ACI (Adaptive Color Interpolation), color correction, hue/gain control, image effect, auto control and auto white balance, or combination thereof. The above-mentioned image processing techniques are well known in the art, and thus their detailed description is omitted.

As shown in FIG. 1, the apparatus 100 for automatically computing a gamma correction curve according to the present invention comprises at least an image obtaining unit 140, a coordinate computing unit 190, and a curve computing unit 200.

The image obtaining unit 140 receives an input image data of a color chart through the image interface 110 at a regular frame interval. As shown in FIG. 4, the color chart is a color test chart used to evaluate color reproduction or color rendering of a color television system and is composed of square color patches arranged according to color.

The coordinate computing unit 190 measures input brightness values of a plurality of ROIs of the image inputted into the image obtaining unit 140, and compares an input brightness value of each ROI with a preset target brightness value of each ROI to compute gamma correction coordinates for a plurality of points of a gamma correction curve.

The curve computing unit 200 applies interpolation to a plurality of the gamma correction coordinates to output a gamma correction curve, and stores a plurality of the gamma correction coordinates that define a profile of a gamma correction curve, into a register of the image signal processor 120 through the image interface 110.

FIG. 2 is a detailed block diagram illustrating a configuration of an apparatus for automatically computing a gamma correction curve according to a preferred embodiment of the present invention.

Referring to FIG. 2, the apparatus 100 for automatically computing a gamma correction curve according to a preferred embodiment of the present invention comprises an image obtaining unit 140, an image storing unit 150, an image operating unit 160, a display 170, an ROI setting unit 180, a coordinate computing unit 190, a curve computing unit 200, a correction verification unit 210, and a GUI (Graphic User Interface) output unit 220.

The image obtaining unit 140 receives an input image data of a color chart through the image interface 110 at a regular frame interval, and stores the image data into the image storing unit 150. The image storing unit 150 is a typical active or inactive memory. The image obtaining unit 140 may convert a color domain of the image data before storing the image data. That is, in the case that a color domain of the input image data is a YUV domain, the image obtaining unit 140 may convert the color domain of the input image data into an RGB domain. The image operating unit 160 scans the image data stored in the image storing unit 150 at a regular frame interval and outputs the image data to the display 170. Accordingly, a color chart image is displayed on the display 170.

The ROI setting unit 180 provides an ROI setting interface to the display 170 through the GUI output unit 220 and receives selection of a plurality of ROIs from a user. Here, ROI means an area of interest, of which a brightness value is to be measured in the color chart outputted through the display 170. The GUI output unit 220 provides a graphic user interface with various data generated during practice of the present invention and with various interfaces provided to a user, through the display 170.

A plurality of ROIs are set to different color patches of the color chart. Preferably, a plurality of ROIs are set to different color patches that belong to the same color of the color chart. More preferably, a plurality of ROIs are continuously set to color patches that belong to the same color of the color chart and have gradual brightness.

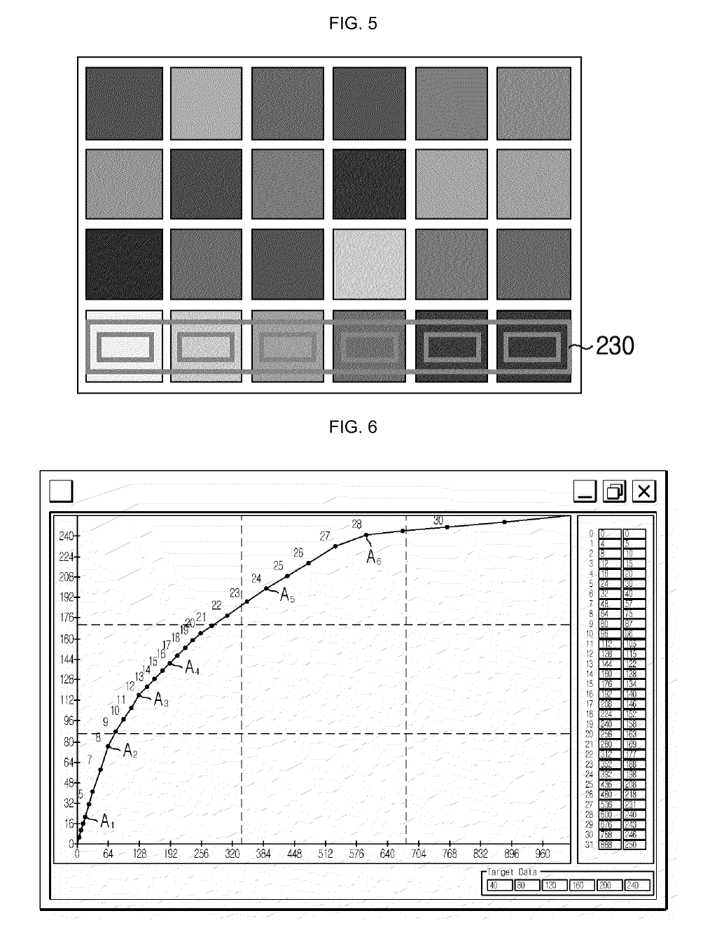

FIG. 5 is an exemplary display view illustrating an ROI setting interface 230 provided through the display 170.

As shown in FIG. 5, the ROI setting interface 230 is used to select an object area for brightness value measurement in the image displayed on the display 170. ROI is an internal square area located in the ROI setting interface 230. However, ROI is not limited to a specific shape. In FIG. 5, ROI is set to each of 6 gray patches that belong to gray color and have decrements of brightness. When setting the ROI, a user moves the ROI setting interface 230 vertically and horizontally using a mouse so that the ROI is located in a color patch.

The coordinate computing unit 190 measures an input brightness value of each ROI set in the color chart. Next, the coordinate computing unit 190 compares an input brightness value of each ROI with a preset target brightness value of each ROI to compute gamma correction coordinates for a plurality of points of a gamma correction curve. The gamma correction coordinate may be computed by the following Equation 1, however the present invention is not limited in this regard.

Gamma correction coordinate: (X_k,Y_k) [Equation 1]

X_k=standard brightness value of patch

Y_k=2*(target brightness value of k-th ROI)—input brightness value of k-th ROI

In the Equation 1, X_k is an X coordinate value of k^{th} gamma correction coordinate and Y_k is a Y coordinate value of k^{th} gamma correction coordinate.

According to the present invention, an input brightness value of each ROI is obtained by averaging input brightness values of all pixels included in each ROI. If 400 pixels are included in ROI, an input brightness value is obtained by averaging input brightness values of 400 pixels. An input brightness value of each pixel is obtained by averaging color values of R, G and B channels. A target brightness value of each ROI may be preset by a user. Alternatively, the target brightness value may be set as a standard value or as a brightness value of a gray patch when a color chart is taken by a certified digital camera. The coordinate computing unit 190 displays a user interface for receiving an input target brightness value on the display 170 to receive a target brightness value of each ROI input from a user. For example, in the case that 6 ROIs are set as shown in FIG. 5, the coordinate computing unit 190 may receive 40, 60, 120, 160, 200 and 240 (based on the decimal system) as a target brightness value of each ROI from left to right.

The curve computing unit 200 inserts additional gamma correction coordinates between a plurality of the gamma correction coordinates computed by the coordinate computing unit 190 using interpolation. Then, a set of gamma correction coordinates defining a profile of a gamma correction curve is computed. The interpolation includes linear interpolation, spline interpolation, cubic interpolation or Bezier interpolation. However, the present invention is not limited to a specific kind of interpolation.

The curve computing unit 200 outputs a set of the computed gamma correction coordinates to the GUI output unit 220. Then, the GUI output unit 220 displays a set of the gamma correction coordinates on a two-dimensional coordinate system, connects adjacent coordinates to form a gamma correction curve, and displays the gamma correction curve on the display 170 through the graphic user interface.

FIG. 6 is an exemplary display view illustrating the gamma correction curve displayed through the graphic user interface by the GUI output unit 220. The gamma correction curve shown in FIG. 6 is formed by computing 6 gamma correction coordinates using 6 ROIs and adding a plurality of gamma correction coordinates between adjacent gamma correction coordinates using interpolation. However, the present invention is not limited to a specific number of gamma correction coordinates. In FIG. 6, 4(A₁), 8(A₂), 12(A₃), 16(A₄), 24(A₅) and 28(A₆) are gamma correction coordinates obtained by a primary computation, and the other coordinates are coordinates added by interpolation.

Meanwhile, after deducing a set of the gamma correction coordinates making up a profile of the gamma correction curve, the curve computing unit 200 stores the deduced gamma correction coordinates into a register of the image signal processor 120 through the image interface 110. Preferably, the curve computing unit 200 stores a set of the gamma correction coordinates in the form of a lookup table. Then, the gamma correction block 130 of the image signal processor 120 corrects a brightness distribution of an image of a subsequent image frame based on the stored gamma correction profile. That is, the gamma correction block 130 corrects a brightness distribution of color for each R, G and B channel by mapping color values of R, G and B channels using the profile of the gamma correction curve stored in the register.

In the above-mentioned embodiment, the gamma correction curve is computed based on an average brightness value for each R, G and B channel, and a profile of the same gamma correction curve is applied when performing gamma correction for each R, G and B channel. However, the gamma correction curve may be computed individually for each R, G and B channel and a set of gamma correction coordinates may be stored into a register for each R, G and B channel. That is, a gamma correction coordinate for each R, G and B channel is computed by measuring input brightness values of a plurality of ROIs for each R, G and B channel, and comparing an input brightness value for each R, G and B channel with a preset target brightness value for each R, G and B channel. If 6 ROIs are set, 6 gamma correction coordinates are computed for each color channel. Next, interpolation is applied to the computed gamma correction coordinates for each R, G and B channel. Accordingly, a set of gamma correction coordinates for each R, G and B channel that forms a gamma correction curve is deduced.

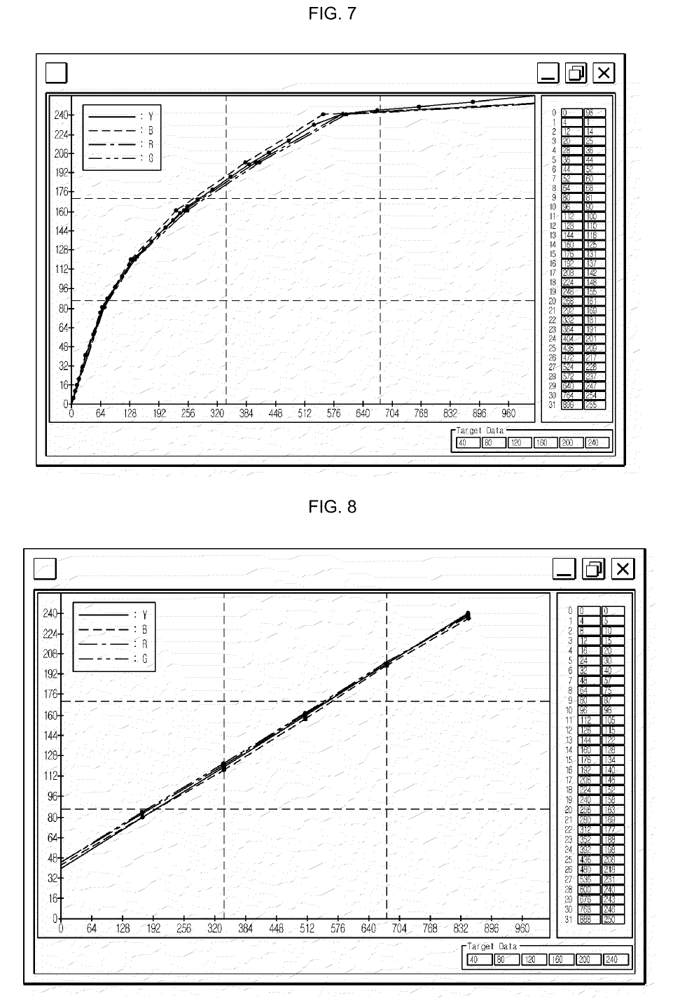

FIG. 7 is an exemplary display view illustrating a gamma correction curve for each R, G and B channel displayed on the display 170 through the GUI output unit 220. In FIG. 7, an R channel gamma correction curve is in red, a G channel gamma correction curve is in green, and a B channel gamma correction curve is in blue. And, a yellow curve is a gamma correction curve formed by averaging the gamma correction curves for R, G and B channels. When outputting a gamma correction curve for each R, G and B channel, the same target brightness value is set to each ROI, however it is possible to set different target brightness values to each ROI.

3 sets of gamma correction coordinates computed for R, G and B channels may be stored into the register of the image signal processor 120 through the image interface 110. In this case, when performing gamma correction, the gamma correction block 130 applies a profile of a gamma correction curve individually for each R, G and B channel to correct a brightness distribution of an image.

The correction verification unit 210 allows to immediately check the application results of the profile of the automatically computed gamma correction curve. That is, when the gamma corrected image is inputted into the image obtaining unit 140 and stored into the image storing unit 150, the correction verification unit 210 computes a brightness distribution for each R, G and B channel and inputs the brightness distribution for each R, G and B channel of ROI into the GUI output unit 220 together with a target brightness distribution of ROI. Then, the GUI output unit 220 outputs the brightness distribution for each R, G and B channel of ROI and the target brightness distribution of ROI to the display 170 in the form of a graph. Preferably, the correction verification unit 210 is operated by a user's explicit call. For this purpose, an output display of the automatically computed gamma correction curve may be provided with a user interface for commanding an operation of the correction verification unit 210.

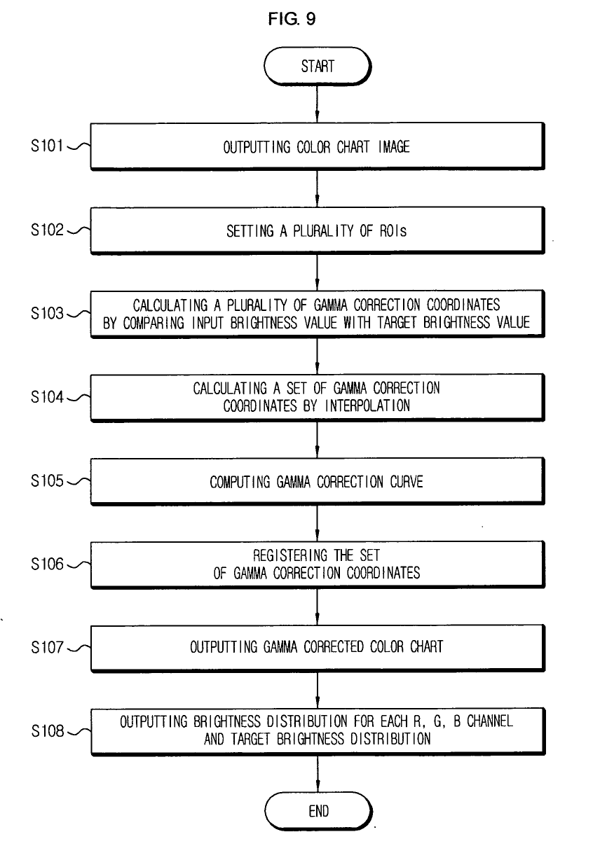

FIG. 8 is an exemplary display view illustrating a brightness distribution for each R, G and B channel of ROI that is computed by the correction verification unit 210 and a target brightness distribution of ROI. In FIG. 8, a brightness distribution of R channel is indicated as a red line, a brightness distribution of G channel is indicated as a green line, a brightness distribution of B channel is indicated as a blue line, and a target brightness distribution is indicated as a yellow line. In the graph, X axis is a standard brightness value of a color patch having ROIs, and Y axis is a brightness value of each of gamma corrected ROIs. Referring to FIG. 8, after the profile of the gamma correction curve is computed and applied to image processing in real time according to the present invention, it is found that a brightness distribution of color for each R, G and B channel is almost matched with a target brightness distribution.

Meanwhile, the gamma correction curve computed automatically according to the present invention may be delicately adjusted in a manual manner. That is, when the profile of the gamma correction curve is automatically computed and outputted to the display 170 through the GUI output unit 220, the user can directly move a break point of the gamma correction curve where the gamma correction coordinate is located, in horizontal and vertical directions using a mouse. When the gamma correction coordinate is changed by the delicate movement of break point, the curve computing unit 200 updates in real time a coordinate value of the moved gamma correction coordinate among gamma correction coordinates stored in the register. The updating of the gamma correction coordinate is easily checked by the correction verification unit 210. That is, when the gamma correction curve is updated according to change of any gamma correction coordinate, thereafter an image applied by the updated gamma correction curve is stored into the image storing unit 150. Then, the correction verification unit 210 computes and displays a brightness distribution for each R, G and B channel of ROI and a target brightness distribution of ROI of the image applied by the updated gamma correction curve, so that the user can immediately check the effect of the manual movement of the gamma correction coordinate. Thus, the gamma correction curve can be delicately adjusted in a manual manner, which results in more accurate gamma correction curve.

FIG. 9 is a flow chart illustrating a method for automatically computing a gamma correction curve according to the present invention. Each step of the method is performed by the above-mentioned apparatus for automatically computing a gamma correction curve.

First, an image data of a color chart is inputted at a regular frame interval through an image interface and outputted to a display (S101).

Next, a ROI setting interface is provided to a user, so that a plurality of ROIs are set in the color chart image outputted on the display (S102). A plurality of the ROIs are continuously set to color patches that belong to the same color of the color chart and have gradual brightness. Preferably, a plurality of the ROIs are set to gray patches. And, each ROI is defined as the inside of a polygon located in the color patch.

After a plurality of the ROIs are set, an input brightness value of each ROI is measured (S103). Next, the input brightness value of each ROI is compared with a preset target brightness value of each ROI to compute gamma correction coordinates for a plurality of points of a gamma correction curve by the above-mentioned Equation 1. The input brightness value of each ROI is obtained by averaging input brightness vales of all pixels included in each ROI. And, an input brightness value of each pixel is obtained by averaging color values for R, G and B channels. The target brightness value of each ROI is set by the user through the user interface.

Alternatively, in the step S103, a plurality of gamma correction coordinates are computed for each R, G and B channel. In this case, an input brightness value of each ROI is compared with a target brightness value of each ROI for each R, G and B channel to compute a plurality of gamma correction coordinates for each R, G and B channel. A target brightness value of each ROI is set equally or differently for each R, G and B channel.

After a plurality of the gamma correction coordinates are computed, additional gamma correction coordinates are inserted between the gamma correction coordinates using interpolation to compute a set of gamma correction coordinates defining a profile of the gamma correction curve (S104). The interpolation includes linear interpolation, spline interpolation, cubic interpolation or Bezier interpolation. However, the present invention is not limited to a specific kind of interpolation. Meanwhile, in the case that a plurality of gamma correction coordinates are computed for each R, G and B channel in the step S103, a set of gamma correction coordinates is computed for each R, G and B channel in the step S104.

After a set of the gamma correction coordinates is computed, the gamma correction coordinates are indicated on a two-dimensional coordinate system, adjacent coordinates are connected by a line to form a gamma correction curve, and the gamma correction curve is displayed on a display (S105). And, a set of the gamma correction coordinates making up a profile of the gamma correction curve is stored into the register of the image signal processor through the image interface (S106). A set of the stored gamma correction coordinates makes up a profile of the gamma correction curve.

Meanwhile, in the case that a set of the gamma correction coordinates is computed for each R, G and B channel in the step S104, the gamma correction curve is displayed on the display for each R, G and B channel in the step S105. Selectively, an average of gamma correction curves for R, G and B channels may be displayed on the display. A set of the stored gamma correction coordinates may be stored into the register of the image signal processor for each R, G and B channel in the step S106.

Next, the color chart image that is gamma corrected by application of the gamma correction curve stored in the register is inputted and displayed on the display (S107). When gamma correcting the color chart image, the same gamma correction curve may be applied to R, G and B channels. Alternatively, an individually assigned gamma correction curve may be applied for each R, G and B channel.

After the gamma corrected color chart image is displayed, a brightness distribution for each R, G and B channel of each ROI is computed and displayed on the display together with a target brightness distribution of each ROI (S108). Thus, the user can immediately check an application effect of the gamma correction curve computed automatically by comparing a brightness distribution for each R, G and B channel of each ROI with a target brightness distribution of each ROI.

Meanwhile, the gamma correction curve computed automatically in the step S105 can be delicately adjusted. That is, after the profile of the gamma correction curve is outputted to the display, when the user moves a break point of the gamma correction curve where the gamma correction coordinates are located, in horizontal and vertical directions using a mouse, a gamma correction coordinate corresponding to the moved break point is changed in response to the movement. And, a coordinate value of the moved gamma correction coordinate among gamma correction coordinates stored in the register through the image interface in the step S106 is updated in real time. When the gamma correction coordinate is updated, a brightness distribution of the image displayed through the display in the step S107 and a brightness distribution for each R, G and B channel of each ROI and a target brightness distribution of each ROI displayed through the display in the step S108 are changed almost in real time. Accordingly, the movement effect of the gamma correction coordinate in a manual manner is immediately checked. After the gamma correction curve is automatically computed, the gamma correction curve can be delicately adjusted in a manual manner, which results in more accurate gamma correction curve.

The method for automatically computing a gamma correction curve according to the present invention may be incorporated in the form of a computer command that can be executed through various computer means and recorded into a computer readable medium. The computer readable medium may contain a program command, a data file or a data structure singularly or in combination. The program command recorded in the computer readable medium may be designed and configured specially for the present invention or may be known to persons skilled in the field of computer program. For example, the computer readable medium includes a magnetic media such as a hard disc, a floppy disc and a magnetic tape, an optical media such as CD-ROM (Compact Disc Read Only Memory) and DVD, a magneto-optical media such as optical disc and hardware configured specially to store and execute a program command, such as ROM (Read Only Memory), RAM (Random Access Memory) and a flash memory. The computer readable medium may be a transmission medium such as an optical cable, a metal wire or a waveguide for carrying a carrier wave that conveys a signal which designates a program command or a data structure. For example, the program command includes machine language code that is made by a complier and a high-level language code that can be executed by a computer using an interpreter. The hardware may be configured to operate as at least one software module to implement the present invention, and vice versa.

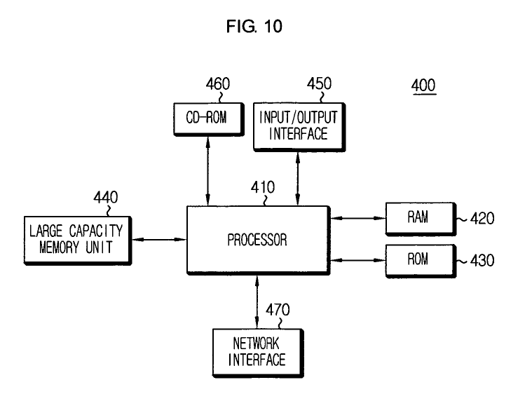

FIG. 10 is an internal block diagram of a general-purpose computer system used to perform the method for automatically computing a gamma correction curve according to the present invention.

The general-purpose computer system 400 comprises at least one processor 410 connected to a main memory unit including RAM 420 and ROM 430. The processor 410 may be referred to as CPU (Central Processing Unit). As well known in the art, the ROM 430 is used to transmit data and command to the processor 410 in one direction, and the RAM 420 is used to transmit data and command to the processor 410 in two directions. The RAM 420 and ROM 430 may be configured as a proper computer readable medium. A large capacity memory unit 440 is connected to the processor 410 in two directions, and provides an additional data storage capacity. The large capacity memory unit 440 may be any one of the above-mentioned computer readable media. The large capacity memory unit 440 is used to store program or data, and typically is a secondary memory unit slower than the main memory unit, for example a hard disc. A specific large capacity memory unit such as a CD-ROM 460 may be used. The processor 410 is connected to at least one input/output interface 450, for example a video monitor, a trackball mouse, a keyboard, a microphone, a touch-screen display, a card reader, a magnetic or paper tape reader, a speech or writing recognizer, a joystick or other well-known computer input/output devices. Finally, the processor 410 may be connected to a wired or wireless communication network through a network interface 470. The above-mentioned process may be performed through the network connection. The above-mentioned devices and tools are well known to ordinary persons skilled in the computer hardware and software technology. Meanwhile, the hardware may be operated by at least one software module to perform operation of the present invention.

Only a few implementations and examples are described and other implementations, enhancements and variations can be made based on what is described and illustrated in this application.

According to an aspect of the present invention, a gamma correction curve is automatically computed, and thus, compared with a conventional art for manually computing a gamma correction curve, the time required to compute the gamma correction curve can be reduced and a more accurate gamma correction curve can be computed.

And, according to another aspect of the present invention, a profile of the automatically computed gamma correction curve is reflected on a register of an image signal processor in real time, and thus the gamma corrected image can be immediately checked. And, a brightness distribution for each color channel can be compared with a target brightness distribution, which makes verification of the gamma correction curve easy.

What is claimed is:

1. Apparatus for automatically computing a gamma correction curve, comprising:
an image obtaining unit for receiving an input image data of a color chart through an image interface;
a coordinate calculating unit for measuring input brightness values of a plurality of ROIs (Regions of Interest) in the input image and comparing an input brightness value of each ROI with a preset target brightness value of each ROI to calculate gamma correction coordinates for a plurality of points of a gamma correction curve; and
a curve computing unit for applying interpolation to a plurality of the calculated gamma correction coordinates to compute a gamma correction curve.

2. The apparatus for automatically computing a gamma correction curve according to claim 1, further comprising:
a ROI setting unit for receiving a selection of ROI from a user by providing an ROI setting interface.

3. The apparatus for automatically computing a gamma correction curve according to claim 1,
wherein the plurality of the ROIs are set to different color patches belonging to the same color of the color chart.

4. The apparatus for automatically computing a gamma correction curve according to claim 3,
wherein the plurality of the ROIs are continuously set to gray patches having gradual brightness.

5. The apparatus for automatically computing a gamma correction curve according to claim 1,
wherein the ROI is a region inside of a polygon located in a color patch of the color chart, and
wherein the input brightness value of each ROI is an average of brightness values of all pixels included in each ROI.

6. The apparatus for automatically computing a gamma correction curve according to claim 1,
wherein the coordinate calculating unit measures an input brightness value for each color channel of ROI and compares the input brightness value for each color channel of ROI with a target brightness value for each color channel of ROI to calculate a gamma correction coordinate for each color channel, and
wherein the curve computing unit computes a gamma correction curve for each color channel.

7. The apparatus for automatically computing a gamma correction curve according to claim 1,
wherein the curve computing unit stores a plurality of gamma correction coordinates into a register of an image signal processor through an image interface where the gamma correction coordinates define a profile of a gamma correction curve.

8. The apparatus for automatically computing a gamma correction curve according to claim 1,
wherein the curve computing unit stores a plurality of gamma correction coordinates into a register of an image signal processor through an image interface where the gamma correction coordinates define a profile of a gamma correction curve for each color channel.

9. The apparatus for automatically computing a gamma correction curve according to claim 1, further comprising:
a GUI (Graphic User Interface) output unit for outputting a gamma correction curve computed by the curve computing unit to a graphic user interface,
wherein the curve computing unit inputs into the GUI output unit a plurality of coordinate values that define a profile of a gamma correction curve, and
the GUI output unit outputs through a display a gamma correction curve corresponding to the plurality of the received coordinate values.

10. The apparatus for automatically computing a gamma correction curve according to claim 6, further comprising:
a GUI output unit for outputting a gamma correction curve for each color channel calculated by the curve computing unit to a graphic user interface,
wherein the curve computing unit inputs into the GUI output unit a plurality of coordinate values that define a profile of a gamma correction curve for each color channel, and
the GUI output unit outputs through a display a gamma correction curve for each color channel corresponding to the plurality of the coordinate values received for each color channel.

11. The apparatus for automatically computing a gamma correction curve according to claim 1, further comprising:
a correction verification unit for calculating a brightness distribution for each color channel of each ROI to verify gamma correction of an image; and
a GUI output unit for outputting the calculated brightness distribution for each color channel to a graphic user interface.

12. The apparatus for automatically computing a gamma correction curve according to claim 11,
wherein the correction verification unit inputs a target brightness distribution of each ROI into the GUI output unit, and
wherein the GUI output unit outputs the target brightness distribution simultaneously with the calculated brightness distribution for each color channel to a graphic user interface.

13. The apparatus for automatically computing a gamma correction curve according to claim 1, wherein the curve computing unit,
receives an amount of adjustment a user made to a gamma correction coordinate, and
updates a profile of the gamma correction curve.

14. A method for automatically computing a gamma correction curve comprising:
an image obtaining step for receiving an input image data of a color chart through an image interface;
a coordinate calculating step for measuring input brightness values of a plurality of ROIs in the input image and comparing an input brightness value of each ROI with a preset target brightness value of each ROI to calculate gamma correction coordinates for a plurality of points of a gamma correction curve; and
a curve computing step for applying interpolation to a plurality of the calculated gamma correction coordinates to compute a gamma correction curve.

15. The method for automatically computing a gamma correction curve according to claim 14, further comprising:
receiving a selection of ROI from a user by providing an ROI setting interface.

16. The method for automatically computing a gamma correction curve according to claim 14,
wherein the plurality of the ROIs are set to different color patches belonging to the same color of the color chart.

17. The method for automatically computing a gamma correction curve according to claim 16,
wherein the plurality of the ROIs are continuously set to gray patches having gradual brightness.

18. The method for automatically computing a gamma correction curve according to claim 14,
wherein the ROI is a region inside of a polygon located in a color patch of the color chart, and
wherein the input brightness value of each ROI is an average of brightness values of all pixels included in each ROI.

19. The method for automatically computing a gamma correction curve according to claim 14,
wherein the coordinate calculating step measures an input brightness value for each color channel of ROI and compares the input brightness value for each color channel of ROI with a target brightness value for each color channel of ROI to calculate a gamma correction coordinate for each color channel, and
wherein the curve computing step computes a gamma correction curve for each color channel.

20. The method for automatically computing a gamma correction curve according to claim 14, further comprising:
storing the plurality of gamma correction coordinates into a register of an image signal processor through an image interface, where the gamma correction coordinates define a profile of a gamma correction curve.

21. The method for automatically computing a gamma correction curve according to claim 20,
where the gamma correction coordinates define a profile of a gamma correction curve for each color channel.

22. The method for automatically computing a gamma correction curve according to claim 14, further comprising:
calculating the plurality of gamma correction coordinates defining a profile of a gamma correction curve; and
outputting to a graphic user interface a gamma correction curve corresponding to the plurality of the calculated gamma correction coordinates.

23. The method for automatically computing a gamma correction curve according to claim 19, further comprising:
calculating a plurality of gamma correction coordinates defining a profile of a gamma correction curve for each color channel; and
outputting to a graphic user interface a gamma correction curve for each color channel corresponding to the plurality of the calculated gamma correction coordinates.

24. The method for automatically computing a gamma correction curve according to claim 14, further comprising:
calculating a brightness distribution for each color channel of each ROI and outputting the brightness distribution to a graphic user interface.

25. The method for automatically computing a gamma correction curve according to claim 24, further comprising:
simultaneously outputting the brightness distribution for each color channel of each ROI and a target brightness distribution of each ROI to a graphic user interface.

26. The method for automatically computing a gamma correction curve according to claim 14, further comprising:
receiving an amount of adjustment a user made to a gamma correction coordinate located on a gamma correction curve; and
updating a profile of a gamma correction curve.

27. A computer readable medium stored thereon a method for automatically computing a gamma correction curve, the method comprising:
an image obtaining step for receiving an input image data of a color chart through an image interface;
a coordinate calculating step for measuring input brightness values of a plurality of ROIs in the input image and comparing an input brightness value of each ROI with a preset target brightness value of each ROI to calculate gamma correction coordinates for a plurality of points of a gamma correction curve; and
a curve computing step for applying interpolation to a plurality of the calculated gamma correction coordinates to compute a gamma correction curve.
